(19) United States
(12) Patent Application Publication
(10) Pub. No.: US 2024/0098432 A1
(43) Pub. Date: Mar. 21, 2024

(54) A METHOD OF OPTIMIZING PARAMETERS IN A HEARING AID SYSTEM AND AN IN-SITU FITTING SYSTEM

(71) Applicant: Widex A/S, Lynge (DK)

(72) Inventor: Jens Brehm Bagger NIELSEN, Lynge (DK)

(73) Assignee: Widex A/S, Lynge (DK)

(21) Appl. No.: 18/272,935

(22) PCT Filed: Feb. 5, 2021
(86) PCT No.: PCT/EP2021/052761

§ 371 Date: Jul. 18, 2023

(51) Int. Cl. H04R 25/00

(52) U.S. Cl. CPC H04R 25/70; H04R 25/507; H04R 2225/55; H04R 2225/81

(57) ABSTRACT

A method of optimizing parameters in a hearing aid system and an in situ fitting system (200).

The present invention relates to a method of optimizing parameters in a hearing aid system. The invention also relates to an in-situ fitting system.

### BACKGROUND OF THE INVENTION

Within the context of the present disclosure a hearing aid can be understood as a small, battery-powered, microelectronic device designed to be worn behind or in the human ear by a hearing-impaired user. Prior to use, the hearing aid is adjusted by a hearing aid fitter according to a prescription. The prescription is based on a hearing test, resulting in a so-called audiogram, of the performance of the hearing-impaired user's unaided hearing. The prescription is developed to reach a setting where the hearing aid will alleviate a hearing loss by amplifying sound at frequencies in those parts of the audible frequency range where the user suffers a hearing deficit. A hearing aid comprises one or more microphones, a battery, a microelectronic circuit comprising a signal processor adapted to provide amplification in those parts of the audible frequency range where the user suffers a hearing deficit, and an acoustic output transducer. The signal processor is preferably a digital signal processor. The hearing aid is enclosed in a casing suitable for fitting behind or in a human ear.

Within the present context a hearing aid system may comprise a single hearing aid (a so called monaural hearing aid system) or comprise two hearing aids, one for each ear of the hearing aid user (a so called binaural hearing aid system). Furthermore the hearing aid system may comprise an external device, such as a smart phone having software applications adapted to interact with other devices of the hearing aid system. Thus within the present context the term “hearing aid system device” may denote a hearing aid or an external device.

Generally a hearing aid system according to the invention is understood as meaning any system which provides an output signal that can be perceived as an acoustic signal by a user or contributes to providing such an output signal and which has means which are used to compensate for an individual hearing loss of the user or contribute to compensating for the hearing loss of the user. These systems may comprise hearing aids which can be worn on the body or on the head, in particular on or in the ear, and can be fully or partially implanted. However, some devices whose main aim is not to compensate for a hearing loss may nevertheless be considered a hearing aid system, for example consumer electronic devices (televisions, hi-fi systems, mobile phones, MP3 players etc.) provided they have measures for compensating for an individual hearing loss.

It is well known within the art of hearing aid systems that most users will benefit from a hearing aid programming (this process may also be denoted fitting) that takes the user's personal preferences into account. This type of fine tuning or optimization of the hearing aid system settings may be denoted personalization or using a more generic term it may be denoted a machine learning procedure. However, it is well known that the process of personalization is a very challenging one.

One problem with personalization is that it may be very difficult for a user to explain in words what types of signal processing and the resulting sounds that are preferred.

Personalization may generally be advantageous with respect to basically all the various types of signal processing that are carried out in a hearing aid system. Thus personalization may be relevant for e.g. noise reduction as well as for classification of the sound environment.

EP-B1-1946609 discloses a method for optimization of hearing aid parameters. The method is based on Bayesian incremental preference elicitation whereby at least one signal processing parameter is adjusted in response to a user adjustment. According to a specific embodiment the user adjustment is simply an indication of user dissent.

EP-B1-1946609 is complicated in so far that it applies a parameterized approach in order to model the user's unknown internal response function (i.e. the user's preference), because it is very difficult to find a suitable parameterized model that suits the great variety of hearing aid system users unknown internal response functions.

Furthermore EP-B1-1946609 is complicated because the processing and memory requirements are very high, especially for hearing aid systems that generally have limited processing and memory resources.

One advanced method for optimizing hearing aid parameters includes interaction between a hearing aid system and an internet server. The advantage of such systems are the abundant processing resources available in the internet server and the suitability of such systems to receive data from a multitude of hearing aid systems and provide some form of processed data back to the multitude of hearing aid systems. In the following such systems may be denoted an in situ fitting system, thus this terminology simply represents a system comprising a hearing aid system and at least one internet server, which are adapted to optimize the setting of at least some of the hearing aid parameters.

It is therefore a feature of the present invention to provide an improved method of optimizing parameters in a hearing aid system with respect to at least ease of use, time spent by the user and the general user satisfaction.

It is another feature of the present invention to provide an in situ fitting system with such improved means for optimizing a hearing aid system setting.

Additionally, the inventor has found that internally generated sounds that are used for providing comfort, be it for masking undesired sounds or for causing a relaxing experience, may benefit significantly from personalization.

In the context of the present disclosure, a relaxing sound should be understood as a sound having a quality whereby it is easy to relax and be relieved of e.g. stress and anxiety when subjected to it. Traditional music is one example of relaxing sound while noise is most often used to refer to a sound that is not relaxing.

In the context of the present disclosure, a relaxing sound may especially be understood as a sound adapted for relieving tinnitus.

However, in the present context, internally generated sounds may also be used for other purposes than providing comfort.

### SUMMARY OF THE INVENTION

The invention, in a first aspect, provides a method of optimizing parameters in a hearing aid system according to claim 1.

This provides an improved method of optimizing parameters in a hearing aid system in order to adapt the hearing aid system to a user's preference.

The invention, in a second aspect, provides an in situ fitting system according to claim 4.

This provides an improved in situ fitting system with respect to user personalization and hearing aid parameter optimization.

Further advantageous features appear from the dependent claims.

Still other features of the present invention will become apparent to those skilled in the art from the following description wherein the invention will be explained in greater detail.

### BRIEF DESCRIPTION OF THE DRAWINGS

By way of example, there is shown and described a preferred embodiment of this invention. As will be realized, the invention is capable of other embodiments, and its several details are capable of modification in various, obvious aspects all without departing from the invention. Accordingly, the drawings and descriptions will be regarded as illustrative in nature and not as restrictive. In the drawings:

FIG. 1 illustrates highly schematically a method of optimizing parameters in a hearing aid system according to an embodiment of the invention, and

FIG. 2 illustrates highly schematically an in situ fitting system according to an embodiment of the invention.

### DETAILED DESCRIPTION

According to an aspect of the invention it has been found that it provides a significant improvement for the user if the hearing aid system settings can be adapted to the user's current preferences (i.e. personalized). This is even more so because the user's preferences may vary significantly up to several times during a day, as a function of e.g. the time of day (morning, afternoon or evening) or the user's mood or the type of activity the user is engaged in.

As a consequence of these varying preferences of many users it provides a significant improvement for the user if the personalization can be carried out without having to spend too much time optimizing the settings.

Furthermore, it has been found that it is of significant importance that the personalization (i.e. the optimization of a hearing aid parameter setting) can be carried out without requiring the user to interact with the hearing aid system in a complex manner.

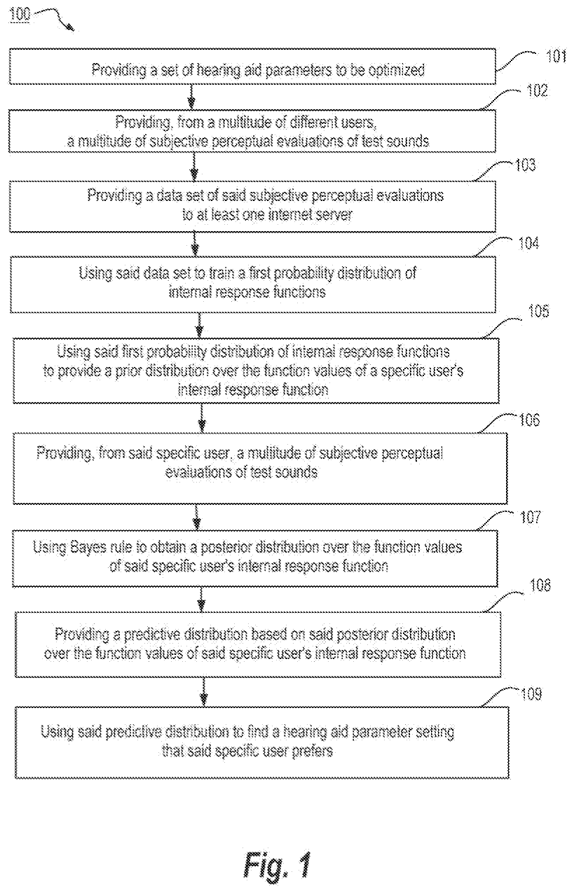

Reference is first made to FIG. 1 which illustrates highly schematically a method 100 of optimizing parameters in a hearing aid system according to a first embodiment of the invention.

According to a first step 101 a set of hearing aid parameters to be optimized is provided.

According to a second step 102 a multitude of subjective perceptual evaluations, from a multitude of different users, of a multitude of test sounds each based on a given hearing aid parameter setting, are provided.

Thus, in the present context a hearing aid parameter setting represents a set of selected values one for each of a corresponding set of parameters. According to a variation the provided hearing aid parameter settings only represents a sub-set of all the parameters required to operate the hearing aid system.

One example of such a sub-set of parameters represent additional gains to be added or subtracted in a set of frequency bands (i.e. these gains may also be denoted fine adjustment gains). In more specific variations the number of frequency bands is three or four. However, more frequency bands such as between 10 and 20 may also be considered dependent obviously on both the available processing power and the number of preferred settings.

It is also noted that according to one embodiment the test sound is provided by having a given hearing aid parameter setting and just listening to the current sound environment in order to make the subjective perceptual evaluation.

According to a more specific embodiment a sound environment used to evaluate a first hearing aid parameter setting is recorded (i.e. the input signal provided by said current sound environment is recorded by the hearing aid or an external device of the hearing aid system) and used for evaluation of subsequent hearing aid parameter settings.

Hereby comparison of different parameter settings for the same sound environment may be optimized.

According to a third step 103 a data set of said multitude of subjective perceptual evaluations is provided to at least one server.

According to a fourth step 104 said data set is used to train a first probability distribution of internal response functions.

According to a fifth step 105 said first probability distribution of internal response functions is used to provide a prior distribution over the function values of a specific user's internal response function.

According to a sixth step 106 a multitude of subjective perceptual evaluations of a multitude of test sounds defined by said set of hearing aid parameters to be optimized is provided from said specific user.

According to a seventh step 107 Bayes rule is used to obtain a posterior distribution over the function values of the specific user's internal response function.

According to an eighth step 108 a predictive distribution based on the posterior distribution over the function values of the specific user's internal response function is provided.

According to the ninth and final step 109 the predictive distribution is used to find a hearing aid parameter setting that the specific user prefers.

According to a specific variation the sixth step 106 comprises the steps of:
providing a first test sound based on a first parameter value setting x₁=[x₁₁, x₂₁, . . . , x_{d1}] and providing a second test sound based on a second parameter value setting x₂=[x₁₂, x₂₂, . . . , x_{d2}];
prompting the specific user to rate said first and second test sounds relative to each other;
providing a user response y₁ representing the user's rating of the two test sounds relative to each other;
providing m user responses y=[y₁, y₂, . . . , yₘ] wherein each of the user responses represent the user's rating of two test sounds relative to each other and wherein the test sounds are derived from a multitude of n parameter value settings x₁, x₂, . . . , xₙ.

Hereby, the amount of information provided from the subjective perceptual evaluations is higher than e.g. evaluations involving only a rating of a single setting or evaluations involving only a selection of either one or the other setting.

According to a further additional variation the seventh step 107 comprises the further steps of:
defining a likelihood function as:

p(yₖ|f(xᵤ),f(xᵥ),σ)

wherein f(xᵤ) and f(xᵥ) represent specific function values of the user's internal response function f, wherein yₖ represents a specific user response and wherein σ represents the noise of the user response;
defining the likelihood as:

$$\\ p ( y \vert f ) = {\prod }_{k = 1}^{m} p ( {y}_{k} \vert f ( {x}_{u} ) , f ( {x}_{v} ) , σ )$$

wherein the likelihood represents a multivariate distribution over the user responses y.

It is a specifically advantageous aspect of the present invention that by training said first probability distribution of internal response functions (according to step 104) using all subjective perceptual evaluations carried out by a multitude of different hearing aid system users an improved result may be obtained compared to the case where the data set of subjective perceptual evaluations only is provided by a single hearing aid system user.

In more specific variations said subjective perceptual evaluations may be carried out in a multitude of different ways, including at least one of:
rating a single hearing aid parameter setting,
comparing two different hearing aid parameter settings and selecting one of the two, and
comparing two different hearing aid parameter settings and rating them comparatively.

Especially the latter type of evaluation is advantageous since it provides most information for training the probability function of internal response functions.

In other more specific variations the training of a probability distribution of internal response functions, is carried out using a method selected from a group comprising at least one of a Gaussian Process, and a Generalized linear model.

The Gaussian Process is especially advantageous because it is processing efficient.

However, it is noted that the method of providing subjective perceptual evaluations by rating a given test sound with a single value (which may rate a single parameter setting independently or may rate the preference towards one out of two test sounds) is much more user friendly than e.g. filling out a questionnaire.

According to a more specific variation said step of using the data set to train a first probability distribution of internal response functions may be carried out e.g. as disclosed in WO-A1-2016004983 with the title “Method of optimizing parameters in a hearing aid system and a hearing aid system” and by the same applicant and which is hereby incorporated by reference. More specifically reference may be given to the disclosure contained from page 14, line 1 and to page 15, line 2.

In another variation the method steps of using a data set of a multitude of subjective perceptual evaluations of a multitude of test sounds each based on a given hearing aid parameter setting, from a multitude of different hearing aid system to train a first probability function of internal response functions only include subjective perceptual evaluations based on hearing aid system users with at least one of: similar audiograms, similar age, same sex and similar cognitive ability or according to yet another variation only include subjective perceptual evaluations made under certain circumstances such as in a specific sound environment.

Hereby the resulting provided prior distribution over the function values of a specific user's internal response function can be customized towards the specific user and his/hers characteristics or towards the specific circumstances.

It is noted that it is well known within the art of hearing aid systems to group similar audiograms (which in the following may also be denoted hearing losses) e.g. in groups like mild, severe and profound hearing loss or in groups like high frequency loss or low frequency loss or combinations of the two types of groups. It will likewise be well known for the skilled person how to evaluate and determine the cognitive ability of users.

According to still other variations the specific user is prompted to initiate a multitude of subjective perceptual evaluations of a multitude of test sounds defined by a set of hearing aid parameters to be optimized in order to find a preferred hearing aid parameter setting, in response to a trigger event selected from a group comprising:
a detection that the current hearing aid parameter setting is too far from a cluster representing a multitude of hearing aid parameter settings that have been preferred by other hearing aid system users, and
a detection that the cognitive stress experienced by the hearing aid system user is above a given threshold.

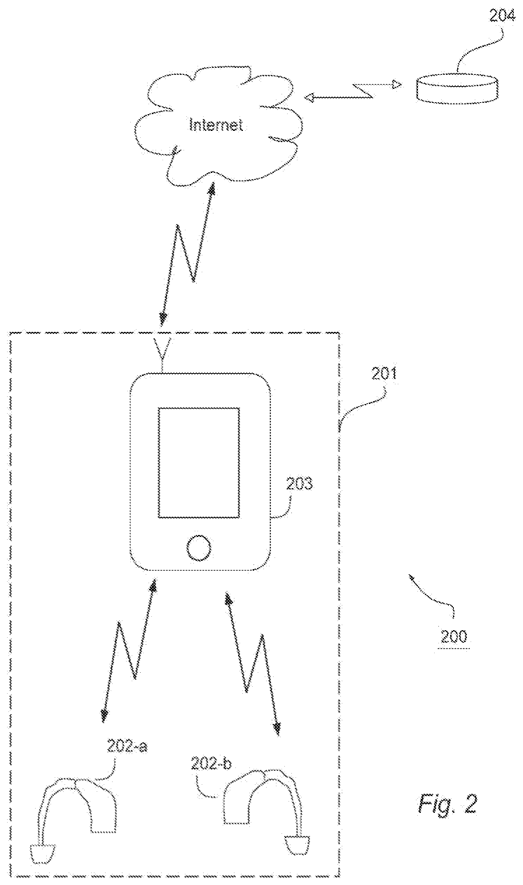

Reference is now made to FIG. 2, which illustrates highly schematically an in situ fitting system 200 according to a second embodiment of the invention.

The in situ fitting system 200 comprises a hearing aid system 201 consisting of a left hearing aid 202-a and a right hearing aid 202-b and an external device, in the form of a smart phone 203 with a specific software application installed. Furthermore the in situ fitting system 200 comprises an internet server 204 that is adapted to receive, over the internet, a data set of a multitude of subjective perceptual evaluations, from a multitude of different users, and adapted to transmit a prior distribution over the function values of a specific user's internal response function to said hearing aid system 201.

In obvious variations the hearing aid system may consist of a single hearing aid (a so called monaural fitting) or may consist of both a left and a right hearing aid (a so called binaural fitting) and furthermore the hearing aid system may (or may not) include an external device 203.

According to other obvious variations a hearing aid or an external device of the hearing aid system is connected directly to the server using a wireless link to the internet, based on e.g. the 3G, 4G or upcoming 5G broadband cellular network technology.

Alternatively, an external device such as a smart phone of the hearing aid system may be used as gateway for the hearing aid, all of which will be well known for the skilled person.

It is noted that the present invention does not require the use of probabilistic methods, although these are preferred because they are more efficient than parametric methods.

It is likewise noted that the present invention is independent on whether the parameters to be optimized are used to control how sound is processed in the hearing aid system or whether they are used to control how sound is synthetically generated by the hearing aid system.

The present invention is also independent on how the hearing aid system parameters are provided or offered or selected for optimization.

Generally, disclosed variations may be combined with all other disclosed variations.

1. A method of optimizing parameters in a hearing aid system comprising the steps of:
providing a set of hearing aid parameters to be optimized;
providing, from a multitude of different users, a multitude of subjective perceptual evaluations of a multitude of test sounds each based on a given hearing aid parameter setting,
providing a data set of said multitude of subjective perceptual evaluations to at least one server;
using said data set to train a first probability distribution of internal response functions;
using said first probability distribution of internal response functions to provide a prior distribution over the function values of a specific user's internal response function;
providing, from said specific user, a multitude of subjective perceptual evaluations of a multitude of test sounds defined by said set of hearing aid parameters to be optimized;
using Bayes rule to obtain a posterior distribution over the function values of the specific user's internal response function;
providing a predictive distribution based on the posterior distribution over the function values of the specific user's internal response function; and
using the predictive distribution to find a hearing aid parameter setting that the specific user prefers.

2. The method according to claim 1, wherein the step of providing from said specific user, a multitude of subjective perceptual evaluations of a multitude of test sounds defined by said set of hearing aid parameters to be optimized comprises the steps of:
providing a first test sound based on a first parameter value setting x₁=[x₁₁, x₂₁, . . . , x_{d1}] and providing a second test sound based on a second parameter value setting x₂=[x₁₂, x₂₂, . . . , x_{d2}];
prompting the specific user to rate said first and second test sounds relative to each other;
providing a user response y₁ representing the user's rating of the two test sounds relative to each other;
providing m user responses y=[y₁, y₂, . . . , yₘ] wherein each of the user responses represent the user's rating of two test sounds relative to each other and wherein the sounds are derived from a multitude of n parameter value settings x₁, x₂, . . . , xₙ.

3. The method according to claim 2, wherein the step of using Bayes rule to obtain a posterior distribution over the function values of the specific user's internal response function comprises the further steps of:
defining a likelihood function as:
p(yₖ|f(xᵤ),f(xᵥ),σ)
wherein f(xᵤ) and f(xᵥ) represent specific function values of the user's internal response function f, wherein yₖ represents a specific user response and wherein σ represents the noise of the user response;
defining the likelihood as:
$$\\ p ( y \vert f ) = {\prod }_{k = 1}^{m} p ( {y}_{k} \vert f ( {x}_{u} ) , f ( {x}_{v} ) , σ )$$
wherein the likelihood represents a multivariate distribution over the user responses y.

4. An in situ fitting system comprising a hearing aid system and an internet server, which are operatively interconnected over the internet and wherein the in situ fitting system is adapted to optimize parameters in a hearing aid system by carrying out the method steps of:
providing a set of hearing aid parameters to be optimized;
providing, from a multitude of different users, a multitude of subjective perceptual evaluations of a multitude of test sounds each based on a given hearing aid parameter setting;
providing a data set of said multitude of subjective perceptual evaluations to at least one server;
using said data set to train a first probability distribution of internal response functions;
using said first probability distribution of internal response functions to provide a prior distribution over the function values of a specific user's internal response function;
providing, from said specific user, a multitude of subjective perceptual evaluations of a multitude of test sounds defined by said set of hearing aid parameters to be optimized;
using Bayes rule to obtain a posterior distribution over the function values of the specific user's internal response function;
providing a predictive distribution based on the posterior distribution over the function values of the specific user's internal response function; and
using the predictive distribution to find a hearing aid parameter setting that the specific user prefers.
